(19) United States
(12) Patent Application Publication
(10) Pub. No.: US 2024/0249267 A1
(43) Pub. Date: Jul. 25, 2024

(54) INFORMATION PROCESSING DEVICE AND DATA PROCESSING METHOD

(71) Applicant: TOSHIBA TEC KABUSHIKI KAISHA, Tokyo (JP)

(72) Inventor: Toshiki Iwai, Sunto Shizuoka (JP)

(21) Appl. No.: 18/495,783

(22) Filed: Oct. 27, 2023

(30) Foreign Application Priority Data
Jan. 20, 2023 (JP) 2023-007467

(51) Int. Cl. G06Q 20/20

(52) U.S. Cl. CPC G06Q 20/208

(57) ABSTRACT

An information processing device includes: a receiving unit to receive processing requests of data collected in a store from a plurality of request sources; a processing unit to execute a predetermined process based on the data of the processing requests received by the receiving unit; a recording unit to record, in association with an identifier for identifying each of the request sources, a processing date and time when the processing unit last processes a processing request received from the request source corresponding to the identifier; and a controller to control, when the receiving unit receives processing requests from a plurality of request sources, the processing unit to preferentially process the processing requests of the request sources from a processing request of a request source that has an early processing date and time based on the processing date and time recorded in association with the identifier of each request source.

### CROSS-REFERENCE TO RELATED APPLICATION

This application is based upon and claims the benefit of priority from Japanese Patent Application No. 2023-007467, filed Jan. 20, 2023, the entire contents of which are incorporated herein by reference.

### FIELD

Embodiments described herein relate generally to an information processing device and a data processing method.

### BACKGROUND

In related art, there is a system in which a server device serving as an information processing device receives processing requests from client terminals serving as request sources and sequentially processes the received processing requests. For example, in the related art, there is proposed a server that calculates and outputs a predicted waiting time in departments by multiplying an average waiting time in departments by the number of persons waiting for processing in the departments when information on one or a plurality of departments serving as destinations is received.

In the server device of the system described above, when processing requests are received from the plurality of client terminals, there is a possibility that processing is executed with a bias toward a specific client terminal. For example, when a processing request is transmitted from another client terminal while or after a plurality of processing requests are continuously transmitted from a specific client terminal, the plurality of processing requests transmitted from the specific client terminal may be preferentially executed.

### DESCRIPTION OF THE DRAWINGS

FIG. 1 illustrates an example of a data processing system according to an embodiment;

FIG. 2 illustrates an example of a hardware configuration of an imaging device;

FIG. 3 illustrates an example of a hardware configuration of a server device;

FIG. 4 illustrates an example of functional configurations of the imaging device and the server device;

FIG. 5 schematically illustrates an example of a state of a processing date-and-time table;

FIG. 6 schematically illustrates an example of the state;

FIG. 7 schematically illustrates an example of the state;

FIG. 8 schematically illustrates an example of the state;

FIG. 9 schematically illustrates an example of the state; and

FIG. 10 is a flowchart illustrating an example of a process performed between the imaging device and the server device.

### DETAILED DESCRIPTION

In general, according to one embodiment, an information processing device and an information processing method capable of equalizing and processing processing requests from a plurality of request sources are provided.

An information processing device according to an embodiment includes: a receiving unit configured to receive processing requests including data collected in a store from a plurality of request sources; a processing unit configured to execute a process based on the data of the processing requests received by the receiving unit; a recording unit configured to record, in association with an identifier for identifying each of the request sources, a processing date and time when the processing unit last processes a processing request received from the request source corresponding to the identifier; and a control unit configured to control, when the receiving unit receives processing requests from a plurality of request sources, the processing unit to preferentially process the processing requests of the request sources from a processing request of a request source that has an earliest processing date and time based on the processing date and time recorded in association with the identifier of each request source.

Hereinafter, an information processing device and a program according to the embodiment will be described with reference to the drawings. In the embodiment described below, an example of application to a store such as a supermarket will be described, but the embodiment is not limited thereto.

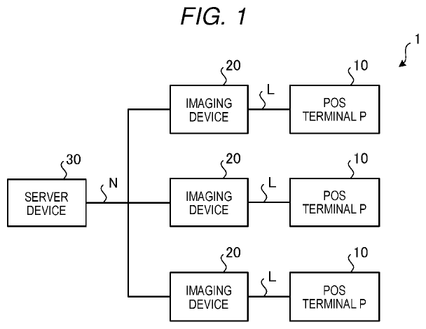

FIG. 1 illustrates an example of a data processing system according to the embodiment. As illustrated in FIG. 1, a data processing system 1 includes POS terminals 10, imaging devices 20, and a server device 30. The POS terminal 10 and the imaging device 20 are communicably connected via a connection line L such as a universal serial bus (USB) cable. The imaging device 20 and the server device 30 are communicably connected via a wired or wireless network N.

The configuration of the data processing system 1 is not limited to the example of FIG. 1. For example, in FIG. 1, the POS terminal 10 and the imaging device 20 are combined as a set and there are three sets, but the number of sets is not limited. Each of the POS terminals 10 may be connected to the network N.

The POS terminal 10 is a sales data processing device that executes sales data processes such as a registration process of a commodity to be purchased by a customer and a payment process of a commodity registered in the registration process. The POS terminal 10 acquires a commodity code of a commodity imaged by the imaging device 20 from the imaging device 20, and executes the registration process and the payment process based on the commodity code.

Specifically, the POS terminal 10 reads commodity information corresponding to the commodity code of the commodity imaged by the imaging device 20 from a commodity master in which a commodity code of each commodity sold in the store is associated with the commodity information such as a commodity name and a price of the commodity. Then, the POS terminal 10 stores the acquired commodity code and commodity information in a storage device such as a random access memory (RAM) to execute the registration process of the commodity purchased by the customer. Further, when the POS terminal 10 receives an operation of instructing to end the registration, the POS terminal 10 calculates a total amount of the commodities based on prices included in the commodity information of the commodities registered so far and quantities of registered commodities. Then, the POS terminal 10 executes the payment process of settling the calculated total amount with a payment amount paid by the customer.

In addition, a seal (hereinafter, also referred to as a service mark) in which a content of a service to be provided is represented by a predetermined mark is attached to a commodity to which a service such as a price reduction or a discount is provided. In this case, the POS terminal 10 acquires the content of the service indicated by the service mark attached to the commodity from the imaging device 20, and applies the service according to the content to the commodity. For example, when the service content indicated by the service mark instructs a price reduction of 100 yen, the POS terminal 10 executes the payment process using a price obtained by reducing 100 yen from a price of a commodity to which the service mark is attached. In addition, for example, when the service content indicated by the service mark indicates a 10% discount, the POS terminal 10 executes the payment process using a price obtained by a price of a commodity to which the service mark is attached being subjected to the 10% discount.

The imaging device 20 is an example of a terminal device (client) that is a request source of processing. The imaging device 20 includes an imaging element such as a charge coupled device (CCD) or a complementary metal oxide-semiconductor (CMOS). The imaging device 20 detects a code symbol such as a bar code or a two-dimensional code from an image (image data) obtained by imaging, and decodes the code symbol to read information included in the code symbol. Then, the imaging device 20 outputs the read information to the POS terminal 10. For example, the imaging device 20 reads the commodity code from the code symbol attached to the commodity and outputs the commodity code to the POS terminal 10. The image acquired by imaging by the imaging device 20 is an example of the data collected in the store.

The imaging device 20 transmits the captured image as a processing request to the server device 30, thereby requesting the server device 30 to process the image. In the present embodiment, a description will be given of a configuration in which the imaging device 20 requests the server device 30 to perform a recognition process of a service mark attached to a commodity. When the imaging device 20 acquires a processing result from the server device 30, the imaging device 20 outputs the acquired processing result to the POS terminal 10. Specifically, when receiving the service content from the server device 30 as the processing result, the imaging device 20 outputs the service content to the POS terminal 10.

The server device 30 is an example of an information processing device. The server device 30 receives a processing request from the imaging device 20, and executes a predetermined process on data of the corresponding processing request. Specifically, when the server device 30 receives a processing request from the imaging device 20, the server device 30 recognizes a service mark from an image included in the processing request, and executes a process of identifying a service content indicated by the recognized service mark. Then, the server device 30 transmits the specific service content to the imaging device 20 that is the request source.

As described above, in the data processing system 1, the server device 30 performs the recognition process of the service mark that generally has a processing load higher than that of reading a code symbol. Therefore, the server device 30 has a hardware configuration specialized for image processing, for example, and a hardware configuration having a processing capability higher than those of the POS terminal 10 and the imaging device 20.

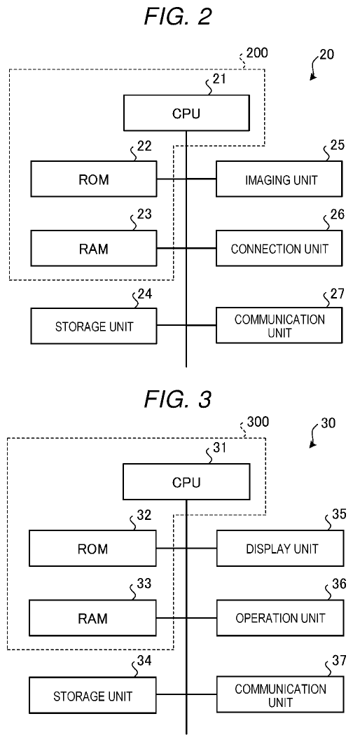

Next, configurations of main devices constituting the data processing system 1 will be described. FIG. 2 illustrates an example of the hardware configuration of the imaging device 20. As illustrated in FIG. 2, the imaging device 20 includes a central processing unit (CPU) 21, a read only memory (ROM) 22, and a random access memory (RAM) 23.

The CPU 21 is an example of a processor, and centrally controls units of the imaging device 20. The ROM 22 stores various programs. The RAM 23 is a workspace for loading programs and various kinds of data.

The CPU 21, the ROM 22, and the RAM 23 are connected via a bus or the like to constitute a control unit 200 having a computer configuration. In the control unit 200, the CPU 21 loads a program stored in a storage unit 24 or the like into the RAM 23, and operates in accordance with the program loaded in the RAM 23 to execute various processes.

The imaging device 20 includes the storage unit 24, an imaging unit 25, a connection unit 26, a communication unit 27, and the like.

The storage unit 24 is an auxiliary storage device such as a flash memory or a solid-state drive (SSD). The storage unit 24 stores various programs executable by the CPU 21 and various kinds of setting information. For example, the storage unit 24 stores a program and setting information for detecting a code symbol from an image and decoding the code symbol.

The imaging unit 25 is a digital camera including an imaging element such as a CCD or a CMOS. In the present embodiment, the imaging unit 25 images a commodity to be purchased by a customer, but an object to be imaged is not limited to commodities.

The connection unit 26 is an interface for connecting to the POS terminal 10. The connection unit 26 is, for example, a USB interface, and is communicably connected to the POS terminal 10. The communication unit 27 is a wired or wireless communication interface that can be connected to the network N. The communication unit 27 is connected to the network N, and transmits and receives various kinds of data to and from the server device 30 or the like connected to the network N.

FIG. 3 illustrates an example of the hardware configuration of the server device 30. As illustrated in FIG. 3, the server device 30 includes a CPU 31, a ROM 32, and a RAM 33.

The CPU 31 is an example of a processor, and centrally controls units of the server device 30. The ROM 32 stores various programs. The RAM 33 is a workspace for loading programs and various kinds of data.

The CPU 31, the ROM 32, and the RAM 33 are connected via a bus or the like to constitute a control unit 300 having a computer configuration. In the control unit 300, the CPU 31 loads a program stored in a storage unit 34 or the like into the RAM 33, and operates in accordance with the loaded program to execute various processes.

The server device 30 includes the storage unit 34, a display unit 35, an operation unit 36, and a communication unit 37.

The storage unit 34 is an auxiliary storage device such as a flash memory or a SSD and a hard disk drive (HDD). The storage unit 34 stores various programs executable by the CPU 31 and various kinds of setting information. For example, the storage unit 34 stores a program and setting information capable of recognizing a service mark from an image and identifying a service content indicated by the service mark.

The display unit 35 is a display device such as a liquid crystal display (LCD). The display unit 35 displays various kinds of information under the control of the CPU 31. The operation unit 36 is an input device such as a keyboard and a pointing device. The operation unit 36 outputs operation contents received from an operator such as a salesclerk to the CPU 31. The operation unit 36 may be a touch panel provided on a display screen of the display unit 35.

The communication unit 37 is a wired or wireless communication interface that can be connected to the network N. The communication unit 37 transmits and receives various kinds of data to and from the imaging device 20 and the like connected to the network N.

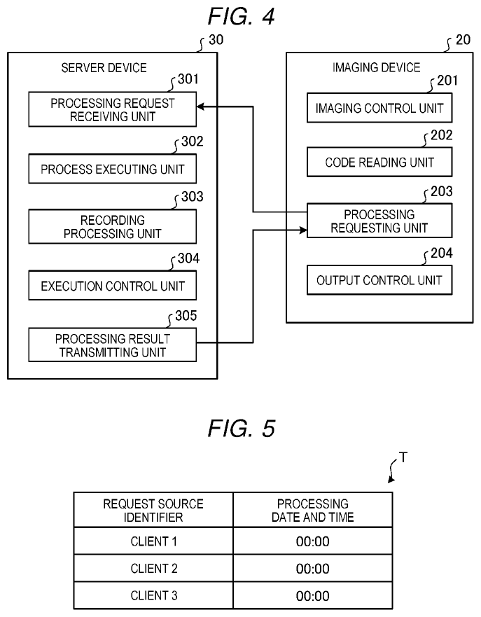

Next, functional configurations of the imaging device 20 and the server device 30 will be described. FIG. 4 illustrates an example of the functional configurations of the imaging device 20 and the server device 30. As illustrated in FIG. 4, the imaging device 20 includes an imaging control unit 201, a code reading unit 202, a processing requesting unit 203, and an output control unit 204 as the functional configuration. Specifically, the control unit 200 (CPU 21) of the imaging device 20 implements the above-described functional configuration by executing a program stored in the ROM 22 or the storage unit 24.

In the present embodiment, the functional configuration of the imaging device 20 is a software configuration implemented by cooperation between the processor of the imaging device 20 and the program, but the disclosure is not limited thereto, and the functional configuration of the imaging device 20 may be a hardware configuration in which a part or the whole functional configuration is implemented using a dedicated circuit or the like.

The imaging control unit 201 of the imaging device 20 controls an operation related to imaging of the imaging unit 25. Specifically, the imaging control unit 201 operates the imaging unit 25 under a predetermined imaging condition, and acquires an image (image data) generated by imaging from the imaging unit 25. For example, the imaging control unit 201 operates the imaging unit 25 at a predetermined frame rate to acquire images generated at a predetermined frame interval.

The code reading unit 202 detects a code symbol from the image acquired by the imaging control unit 201. The code reading unit 202 decodes the detected code symbol to read information included in the code symbol. For example, when a code symbol attached to a commodity is imaged by the imaging unit 25, the code reading unit 202 detects the code symbol from the image acquired by the imaging control unit 201 and reads a commodity code for identifying the commodity.

The processing requesting unit 203 transmits a processing request including the image acquired by the imaging control unit 201 to the server device 30. Here, the processing requesting unit 203 makes an identifier (hereinafter, also referred to as a request source identifier) capable of identifying the host imaging device 20 (or the POS terminal 10 in one set), which is a request source, to be included in a processing request (or together with a processing request), and transmits the processing request including the identifier to the server device 30. The identifier may be, for example, an IP address or a host name of the imaging device 20. In addition, the processing requesting unit 203 may make an identifier capable of identifying processing requests to be included in a processing request.

In addition, the processing requesting unit 203 receives a processing result from the server device 30 as a response to the processing request. Specifically, the processing requesting unit 203 receives, from the server device 30, a presence or absence of the service mark and a processing result indicating a service content of the service mark.

In addition, the processing requesting unit 203 may restrict a period in which an image to be transmitted as a processing request or a processing requirement is made according to a reading result or the like of the code reading unit 202. For example, the processing requesting unit 203 may sequentially transmit processing requests for the images in which the code symbol is detected by the code reading unit 202. Further, for example, the processing requesting unit 203 may set an imaging timing of the image in which the code symbol is detected by the code reading unit 202 as a base point, and sequentially transmit the processing requests for images captured within a predetermined time from the base point.

The output control unit 204 controls a data output to the POS terminal 10. Specifically, the output control unit 204 outputs the reading result of the code reading unit 202 to the POS terminal 10. The output control unit 204 outputs the processing result received by the processing requesting unit 203 from the server device 30 to the POS terminal 10.

The output control unit 204 may output the commodity code, which is the reading result of the code reading unit 202, and the processing result of the server device 30 together or individually. When the processing result of the server device 30 indicates no service mark, the output control unit 204 may prevent an output of the processing result.

The output control unit 204 may control the number of outputs of the reading result and the processing result respectively output for the same commodity to be one. For example, when one commodity code is read and then the same commodity code is read again or a plurality of times within a predetermined time, the output control unit 204 may discard the commodity code read within the predetermined time. Further, for example, when one service content is received as the processing result and then a processing result indicating the same service content is received again or a plurality of times within the predetermined time, the output control unit 204 may discard the received service content within the predetermined time.

On the other hand, the server device 30 includes a processing request receiving unit 301, a process executing unit 302, a recording processing unit 303, an execution control unit 304, and a processing result transmitting unit 305 as a functional configuration. Specifically, the control unit 300 (CPU 31) of the server device 30 implements the above-described functional configuration by executing a program stored in the ROM 32 or the storage unit 34.

In the present embodiment, the functional configuration of the server device 30 is a software configuration implemented by cooperation between the processor of the server device 30 and the program, but the disclosure is not limited thereto, and the functional configuration of the server device 30 may be a hardware configuration in which a part or the whole functional configuration is implemented using a dedicated circuit or the like.

The processing request receiving unit 301 is an example of a receiving unit and a storage control unit. The processing request receiving unit 301 receives processing requests of images collected in a store from the plurality of imaging devices 20. The processing request receiving unit 301 stores the received processing request in a storage area (hereinafter also referred to as a processing waiting memory) reserved in the RAM 33 or the storage unit 34. Here, the processing request stored in the processing waiting memory is a processing request that is not subjected to a process performed by the process executing unit 302 described later.

Specifically, when the processing request receiving unit 301 receives the processing request from the imaging device 20, the processing request receiving unit 301 associates the image to be processed included in the processing request with the request source identifier for identifying the imaging device 20 serving as the request source, and stores the associated image and request source identifier in the processing waiting memory. The processing request receiving unit 301 stores the processing request in the processing waiting memory in a received order.

The process executing unit 302 is an example of a processing unit. The process executing unit 302 executes a predetermined process based on the image of the processing request received by the processing request receiving unit 301. Specifically, under the control of the execution control unit 304, the process executing unit 302 reads a processing request as an execution target from the processing waiting memory, and executes the predetermined process on the image included in the processing request. It is assumed that the processing request read by the process executing unit 302 is loaded in the RAM 33 or the like to be deleted from the processing waiting memory.

A processing content executed by the process executing unit 302 is not particularly limited, and in the present embodiment, a process related to the service mark recognition is executed. For example, the process executing unit 302 uses a known technique such as an image recognition technique to recognize the service mark from the image included in the processing request and identify the service content indicated by the service mark. Then, the process executing unit 302 outputs the presence or absence of the service mark and the service content indicated by the recognized service mark as the processing result. In the present embodiment, it is assumed that the process executing unit 302 has a single-threaded configuration capable of processing one processing request at a time.

The recording processing unit 303 is an example of a recording unit. The recording processing unit 303 records a processing date and time which is associated with the request source identifier for identifying the imaging devices 20 and at which the process executing unit 302 lastly processes the processing request received from the imaging device 20 corresponding to the request source identifier. Specifically, the recording processing unit 303 records and manages the processing date and time at which the process executing unit 302 lastly processes the processing request received from the imaging device 20 by using a processing date-and-time table T in which the request source identifiers of the imaging devices 20 are registered. The processing date-and-time table T is held in, for example, the RAM 33 or the storage unit 34.

When the process executing unit 302 starts a process based on the processing request, the recording processing unit 303 sets a date and time at which the process is started as the processing date and time, and records the process date and time in the processing date-and-time table T in association with a request source identifier of a request source of the processing request. The recording processing unit 303 may record an end date and time, which is a timing when the process executed by the process executing unit 302 ends, as the processing date and time.

The execution control unit 304 is an example of a control unit. When the processing request receiving unit 301 receives the processing requests from the plurality of imaging devices 20, the execution control unit 304 controls the process executing unit 302 to preferentially process the processing request of the request source that has an early processing date and time based on the processing date and time recorded in association with the request source identifiers of the imaging devices 20.

Specifically, when the processing request receiving unit 301 receives a processing request from a plurality of request sources, that is, when a plurality of processing requests are stored in the processing waiting memory, the execution control unit 304 performs the following processes in order to select, from these processing requests, a processing request to be executed by the process executing unit 302 next. First, the execution control unit 304 searches the processing date-and-time table T for the processing date and time associated with the request source identifier of the processing requests in a processing waiting state. Next, the execution control unit 304 compares the searched processing date and time to identify a request source identifier having an earlier processing date and time, and sets one of the processing requests of the specific request source identifier as the execution target. Therefore, when the process of the processing request that is currently executed is ended, the recording processing unit 303 reads the processing request set as the execution target from the processing waiting memory and starts a next process.

When a plurality of processing requests having the same request source identifier are stored in the processing waiting memory, the execution control unit 304 selects one of the plurality of processing requests and sets the selected processing request as the execution target, and in this case, it is preferable that the execution control unit 304 set, as the execution target, the processing request in order from the processing request previously stored in the processing waiting memory. If a single processing request is stored in the processing waiting memory, by setting the processing request as the execution target, the execution control unit 304 controls the process executing unit 302 to immediately process the processing request.

Here, an operation example of the processing request receiving unit 301, the process executing unit 302, the recording processing unit 303, and the execution control unit 304 will be described with reference to FIGS. 5 to 9. FIGS. 5 to 9 schematically illustrate examples of a state of the processing date-and-time table T.

The processing date-and-time table T in FIG. 5 illustrates an initial state of the processing date-and-time table T. In the processing date-and-time table T, the request source identifiers (clients 1 to 3) of the three imaging devices 20 illustrated in FIG. 1 are registered. The processing date and times of the request source identifiers are set to “00: 00” in the initial state. That is, the processing date-and-time table T in FIG. 5 indicates the initial state where the process based on the processing request is not performed on any of clients 1 to 3.

In this initial state, for example, when the processing requests are transmitted at the substantially same timing from the respective clients 1 to 3, the processing request receiving unit 301 stores the processing requests received from the clients 1 to 3 in the processing waiting memory. The substantially same timing is not limited to the same timing, and is, for example, a concept also including a period from a reception timing of the previously received processing request to a start of the process of the processing request.

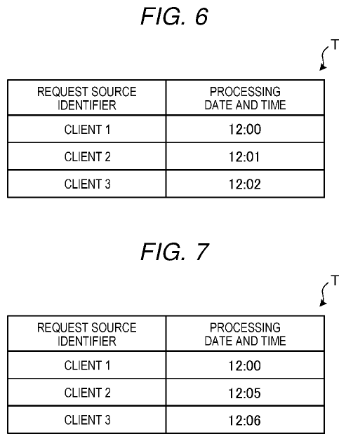

Next, the execution control unit 304 refers to the processing date-and-time table T, and determines a processing request as the execution target from the processing requests of the clients 1 to 3 stored in the processing waiting memory. When the processing date-and-time table T is in the state of FIG. 5, since the processing date and times of the clients 1 to 3 are the same, the execution control unit 304 preferentially sets the execution target from one having a small number of the request source identifier, for example, and controls the process executing unit 302 to process the execution target. In this case, the execution control unit 304 controls the process executing unit 302 to sequentially execute the process on the processing requests in an order of the client 1 to 3. As a result, in the processing date-and-time table T, for example, as illustrated in FIG. 6, more recent processing date and times are recorded in the order of the clients 1 to 3.

A method of determining the execution target when the processing date and times are the same is not limited thereto. For example, the execution target may be preferentially determined from one having a large number of the request source identifier, or the execution target may be randomly determined.

Next, in the state of the processing date-and-time table T illustrated in FIG. 6, for example, when the processing requests are transmitted at the substantially same timing from the clients 2 and 3, the processing request receiving unit 301 stores the processing requests received from the clients 2 and 3 in the processing waiting memory. Next, the execution control unit 304 refers to the processing date-and-time table T, and determines a processing request as the execution target from the processing requests of the clients 2 and 3 stored in the processing waiting memory.

When the processing date-and-time table T is in the state of FIG. 6, since the processing date and time of the client 2 is earlier than the processing date and time of the client 3, the execution control unit 304 sets the processing request of the client 2 as the execution target, for example, and controls the process executing unit 302 to process the execution target. Then, when the processing request of the client 3 is stored in the processing waiting memory at a time point when the process of the processing request of the client 2 is completed, the execution control unit 304 sets the processing request of the client 3 as the execution target, and controls the process executing unit 302 to process the execution target. As a result, in the processing date-and-time table T, for example, as illustrated in FIG. 7, more recent processing date and times are recorded in the order of the clients 1 to 3.

Next, in the state of the processing date-and-time table T illustrated in FIG. 7, for example, when the processing requests are transmitted at the substantially same timing from the clients 1 and 3, the processing request receiving unit 301 stores the processing requests received from the clients 1 and 3 in the processing waiting memory. Next, the execution control unit 304 refers to the processing date-and-time table T, and determines a processing request as the execution target from the processing requests of the clients 1 and 3 stored in the processing waiting memory.

When the processing date-and-time table T is in the state of FIG. 7, since the processing date and time of the client 1 is earlier than the processing date and time of the client 3, the execution control unit 304 preferentially sets the processing request of the client 1 as the execution target, for example, and controls the process executing unit 302 to process the execution target. Then, when the processing request of the client 3 is stored in the processing waiting memory at a time point when the process of the processing request of the client 1 is completed, the execution control unit 304 sets the processing request of the client 3 as the execution target, and controls the process executing unit 302 to process the execution target. As a result, in the processing date-and-time table T, for example, as illustrated in FIG. 8, more recent processing date and times are recorded in an order of the clients 2, 1, 3.

Next, in the state of the processing date-and-time table T illustrated in FIG. 8, for example, when the processing requests are transmitted at the substantially same timing from the clients 1 to 3, the processing request receiving unit 301 stores the processing requests received from the clients 1 to 3 in the processing waiting memory. Next, the execution control unit 304 refers to the processing date-and-time table T, and determines a processing request as the execution target from the processing requests of the clients 1 to 3 stored in the processing waiting memory.

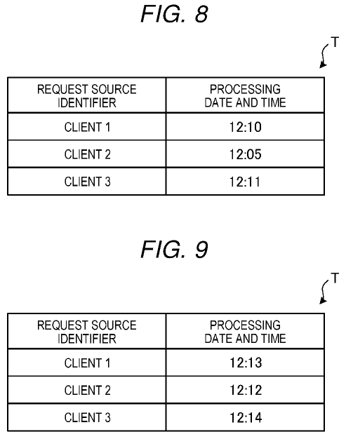

When the processing date-and-time table T is in the state of FIG. 8, since the processing date and time of the client 2 is the earliest, the execution control unit 304 sets the processing request of the client 2 as the execution target, for example, and controls the process executing unit 302 to process the execution target. Further, when the processing requests of the clients 1 and 3 are stored in the processing waiting memory at the time point when the process of the processing request of the client 2 is completed, the execution control unit 304 sets the processing request of the client 1 that has an earlier processing date and time as the execution target, and controls the process executing unit 302 to process the execution target. Further, when the remaining processing request of the client 3 is stored in the processing waiting memory at the time point when the process of the processing request of the client 1 is completed, the execution control unit 304 sets the processing request of the client 3 as the execution target, and controls the process executing unit 302 to process the execution target. As a result, in the processing date-and-time table T, for example, as illustrated in FIG. 9, more recent processing date and times are recorded in an order of the clients 2, 1, 3.

As described above, when there are processing requests from the plurality of request sources, the execution control unit 304 compares the processing date and times at which the process is last executed with respect to the request sources, and controls the process executing unit 302 to preferentially execute the process from the processing request of the request source that has the early processing date and time.

Accordingly, in the server device 30, the processing requests from the clients 1 to 3 can be equalized and processed. Therefore, for example, even when a plurality of processing requests are consecutively transmitted from a specific request source, it is possible to process the processing requests from another request source without being biased toward the process of the specific request source.

Returning to FIG. 4, the processing result transmitting unit 305 is an example of an output unit. When the process based on the processing request is completed by the process executing unit 302, the processing result transmitting unit 305 transmits the processing result to the imaging device 20 corresponding to the request source identifier of the processing request. Specifically, the processing result transmitting unit 305 transmits the recognition result of the service mark executed by the process executing unit 302 to the imaging device 20 as the request source.

Accordingly, in the imaging device 20, the processing requesting unit 203 acquires the recognition result of the service mark from the server device 30 in response to the processing request. Then, the recognition result of the service mark is output from the imaging device 20 to the POS terminal 10, so that a price reduction, a discount, or the like of the commodity based on the recognition result of the service mark is performed in the POS terminal 10.

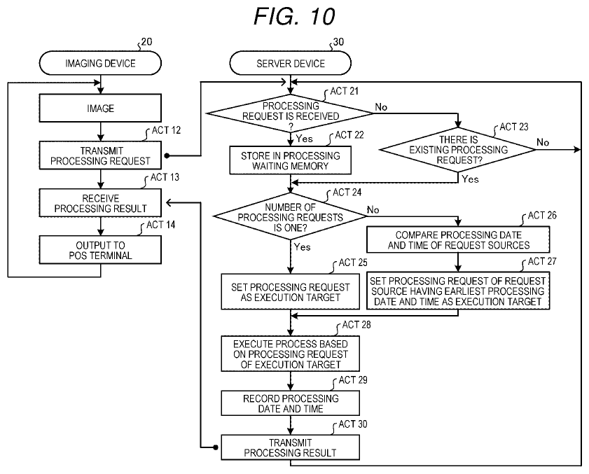

Hereinafter, an example of a process performed between the imaging device 20 and the server device 30 will be described with reference to FIG. 10. FIG. 10 is a flowchart illustrating the example of the process performed between the imaging device 20 and the server device 30. Although FIG. 10 illustrates the process of one imaging device 20, the same process is also performed in other imaging devices 20.

When the imaging unit 25 of the imaging device 20 images a commodity (ACT 11), the processing requesting unit 203 transmits a processing request including an image obtained by imaging to the server device 30 (ACT 12).

On the other hand, in the server device 30, the processing request receiving unit 301 determines whether the processing request is received (ACT 21). If the processing request receiving unit 301 receives the processing request from any imaging device 20 (ACT 21; Yes), the processing request receiving unit 301 stores the received processing request in the processing waiting memory (ACT 22), and the process proceeds to ACT 24.

If the processing request receiving unit 301 does not receive the processing request (ACT 21; No), the execution control unit 304 determines whether an existing processing request is stored in the processing waiting memory (ACT 23). Here, if the processing request is not stored in the processing waiting memory (ACT 23; No), the process returns to ACT 21. If the processing request is stored in the processing waiting memory (ACT 23; Yes), the process proceeds to ACT 24.

Subsequently, the execution control unit 304 determines whether the number of processing requests stored in the processing waiting memory is one or more (ACT 24). Here, if a single processing request is stored in the processing waiting memory (ACT 24; Yes), the execution control unit 304 sets the processing request as an execution target (ACT 25), and the process proceeds to ACT 28.

If a plurality of processing requests are stored in the processing waiting memory (ACT 24; No), the execution control unit 304 refers to the processing date-and-time table T and compares the processing date and time associated with the request source identifier of the request source of the processing request (ACT 26). Next, the execution control unit 304 sets the processing request of the request source identifier that has the earliest processing date and time as an execution target (ACT 27), and the process proceeds to ACT 28.

Subsequently, the process executing unit 302 reads the processing request set in ACT 25 or ACT 27 from the processing waiting memory, and executes the process of recognizing the service mark from the image included in the processing request (ACT 28). If the process is started by the process executing unit 302, the recording processing unit 303 records the processing date and time in the processing date-and-time table in association with the request source identifier of the processing request to be processed (ACT 29).

When the process of the process executing unit 302 is ended, the transmitting unit 305 transmits the processing result of the process executing unit 302 to the imaging device 20 as the request source (ACT 30), and returns the process to ACT 21.

In the imaging device 20, if the processing requesting unit 203 receives the processing result as a response to the processing request (ACT 13), the output control unit 204 outputs the processing result to the POS terminal 10 (ACT 14), and returns the process to ACT 11.

As described above, the server device 30 according to the present embodiment receives processing requests of data collected in a store from a plurality of request sources, executes a predetermined process based on the data of the received processing requests, and records an executed processing date and time in association with the request source identifier of the request source. When the server device 30 receives processing requests from a plurality of request sources, the server device 30 preferentially executes the process from the processing request of the request source that has an early processing date and time based on the processing date and times recorded in association with the request source identifiers of the respective request source.

As described above, in the server device 30 according to the present embodiment, it is possible to determine the processing request to be processed next as the execution target based on the processing date and time when the processing request of the request source is processed last. Therefore, for example, in the server device 30, even when a plurality of processing requests are consecutively transmitted from a specific request source, it is possible to equalize and process the processing requests from a plurality of request sources without performing a process with a bias toward the specific request source.

The above-described embodiment may also be modified and implemented as appropriate by changing a part of the configuration or the function of each device described above. Hereinafter, plural modifications of the above-described embodiment will be described as other embodiments. In the following description, differences from the above-described embodiment will be mainly described, and detailed description of points common to those described above will be omitted. In addition, modifications described below may be individually implemented or may be implemented in combination as appropriate.

### Modification 1

In the above-described embodiment, an example of a device unit in which the request source of the processing request is the imaging device 20 is described. However, the request source of the processing request is not limited to the device unit. For example, when one imaging device 20 includes a plurality of processing requesting units 203, processing requests are transmitted from the processing requesting units 203. In this case, processes related to the implementation of the processing requesting units 203 become request sources.

When the request source of the processing request is set as the process unit, the configuration and the operation of the server device 30 described above can be applied by setting, as the request source identifier, a combination of the identifier of the imaging device 20 and the identifier of processes and managing the request source identifier in the processing waiting memory and the processing date-and-time table T. Therefore, even when the request source of the processing request is set as the process unit, the same effects as those of the above-described embodiment can be achieved.

### Modification 2

In the above-described embodiment, the processing contents requested by the processing requesting units 203 to the server device 30 are the same, but the disclosure is not limited thereto, and the processing requesting units 203 may request different processing contents to the server device 30.

For example, a part of the processing requesting units 203 may request the process of recognizing the service mark from the image, and the remaining processing requesting units 203 may request a process of recognizing other marks or information from the image.

The processing content requested by the processing requesting units 203 to the server device 30 is not limited to the processing content related to the commercial transaction, and may be other processing contents. For example, the processing requesting unit 203 may request a process of recognizing a behavior of the customer or a person from the image captured in the store to the server device 30.

### Modification 3

In the above-described embodiment, the single-threaded configuration capable of executing only a single processing request by the server device 30 is described, but the disclosure is not limited thereto, and the configuration may be a multi-threaded configuration capable of executing a plurality of processing requests in parallel.

In this case, the execution control unit 304 controls the process executing unit 302 to execute processing requests corresponding to the number of threads that can be executed at a time in the server device 30. When the processing requests exceeding the number of threads are stored in the processing waiting memory, the execution control unit 304 refers to the processing date-and-time table T and sets the processing request to be processed based on the processing date and times corresponding to the request source identifiers corresponding to the request sources of the processing requests. Specifically, the execution control unit 304 selects the request source identifiers corresponding to the number of threads in order of the early processing date and time, and determines the processing request related to the selected request source identifier as the execution target.

Accordingly, even in a configuration in which the server device 30 executes the request processing in the multi-threaded manner, the same effect as in the above-described embodiment can be achieved. When the configuration of the present modification is employed, it is preferable that the recording processing unit 303 record a date and time when the process is started in the processing date-and-time table T as the processing date and time.

The program executed by each device in the above-described embodiment is provided in a state of being incorporated in advance in a ROM, a storage unit, or the like. The program executed by each device in the above-described embodiment may be provided by being recorded in a computer-readable recording medium such as a CD-ROM, a flexible disc (FD), a CD-R, or a digital versatile disk (DVD) as a file in an installable or executable format.

Furthermore, the program executed by each device in the above-described embodiment may be stored in a computer connected to a network such as the Internet, and may be provided by being downloaded via the network. The program executed by each device in the above-described embodiment may be provided or distributed via a network such as the Internet.

While embodiments have been described, the embodiments have been presented by way of example and are not intended to limit the scope of the exemplary embodiments. These novel embodiments and the modifications thereof can be implemented in various other forms, and various omissions, replacements, modifications, and combinations can be made without departing from the gist of the disclosure. The embodiments and the modifications thereof are included in the scope and the gist of the exemplary embodiments, and are included in a scope of the exemplary embodiments disclosed in the claims and equivalents thereof.

What is claimed is:

1. An information processing device, comprising:
a receiving component configured to receive processing requests of data collected in a store from a plurality of request sources;
a processing component configured to execute a predetermined process based on the data of the processing requests received by the receiving component;
a recording component configured to record, in association with an identifier for identifying each of the plurality of request sources, a processing date and time when the processing component last processes a processing request received from a request source corresponding to the identifier; and
a controller configured to control, when the receiving component receives processing requests from the plurality of request sources, the processing component to preferentially process the processing requests of the plurality of request sources from a processing request of a request source that has an early processing date and time based on the processing date and time recorded in association with the identifier of each of the plurality of request sources.

2. The information processing device according to claim 1, wherein
when the receiving component receives processing requests from the plurality of request sources, the controller sets one of the processing requests of the plurality of request sources that has an early processing date and time as an execution target, and controls the processing component to process the processing request.

3. The information processing device according to claim 1, further comprising:
a storage controller configured to store, in a storage component, a processing request that is not processed by the processing component among the processing requests received by the receiving component, wherein
when a plurality of processing requests are stored in the storage component, the controller determines that the receiving component receives processing requests from the plurality of request sources.

4. The information processing device according to claim 1, further comprising:
an output component configured to output a processing result of a processing request executed by the processing component to a request source of the processing request.

5. The information processing device according to claim 1, wherein
the receiving component receives the processing requests from terminal devices serving as request sources of the processing requests or processes operating on the terminal devices.

6. The information processing device according to claim 1, wherein the receiving component receives processing requests of data collected in the store from a plurality of image sources.

7. The information processing device according to claim 1, wherein the data collected in the store includes a commodity code.

8. An information processing method, comprising:
receiving processing requests of data collected in a store from a plurality of request sources;
executing a predetermined process based on the data of the processing requests;
recording, in association with an identifier for identifying each of the plurality of request sources, a processing date and time when a processing request received from a request source corresponding to the identifier is last processed; and
processing preferentially, when processing requests are received from the plurality of request sources, the processing requests of the plurality of request sources from a processing request of a request source that has an early processing date and time based on the processing date and time recorded in association with the identifier of each of the plurality of request sources.

9. The information processing method according to claim 8, further comprising:
when receiving processing requests from the plurality of request sources, setting one of the processing requests of the plurality of request sources that has an early processing date and time as an execution target, and processing the processing request.

10. The information processing method according to claim 8, further comprising:
storing a processing request that is not processed by the processing among the processing requests received; and
when a plurality of processing requests are stored, determining that processing requests from the plurality of request sources are received.

11. The information processing method according to claim 8, further comprising:
outputting a processing result of a processing request executed to a request source of the processing request.

12. The information processing method according to claim 8, further comprising:
receiving the processing requests from terminal devices serving as request sources of the processing requests or processes operating on the terminal devices.

13. The information processing method according to claim 8, further comprising:
receiving processing requests of data collected in the store from a plurality of image sources.

14. A point of sales terminal, comprising:
a registration component to register a commodity to be purchased by a customer;
a payment component to process payment of the commodity;
a receiving component configured to receive processing requests of data collected in a store from a plurality of request sources;
a processing component configured to execute a predetermined process based on the data of the processing requests received by the receiving component;
a recording component configured to record, in association with an identifier for identifying each of the plurality of request sources, a processing date and time when the processing component last processes a processing request received from a request source corresponding to the identifier; and
a controller configured to control, when the receiving component receives processing requests from the plurality of request sources, the processing component to preferentially process the processing requests of the plurality of request sources from a processing request of a request source that has an early processing date and time based on the processing date and time recorded in association with the identifier of each of the plurality of request sources.

15. The point of sales terminal according to claim 14, wherein
when the receiving component receives processing requests from the plurality of request sources, the controller sets one of the processing requests of the plurality of request sources that has an early processing date and time as an execution target, and controls the processing component to process the processing request.

16. The point of sales terminal according to claim 14, further comprising:
a storage controller configured to store, in a storage component, a processing request that is not processed by the processing component among the processing requests received by the receiving component, wherein
when a plurality of processing requests are stored in the storage component, the controller determines that the receiving component receives processing requests from the plurality of request sources.

17. The point of sales terminal according to claim 14, further comprising:
an output component configured to output a processing result of a processing request executed by the processing component to a request source of the processing request.

18. The point of sales terminal according to claim 14, wherein
the receiving component receives the processing requests from terminal devices serving as request sources of the processing requests or processes operating on the terminal devices.

19. The point of sales terminal according to claim 14, wherein the receiving component receives processing requests of data collected in the store from a plurality of image sources.

20. The point of sales terminal according to claim 14, wherein the data collected in the store includes a commodity code.
